(19) United States
(12) Patent Application Publication
(10) Pub. No.: US 2023/0178795 A1
(43) Pub. Date: Jun. 8, 2023

(54) LITHIUM-ION CONDUCTIVE CERAMIC MATERIAL AND PROCESS

(71) Applicant: JOHNSON MATTHEY PUBLIC LIMITED COMPANY, London (GB)

(72) Inventors: Christopher John NUTTALL, Reading (GB); Enrico PETRUCCO, Reading (GB)

(21) Appl. No.: 17/997,956

(22) PCT Filed: May 6, 2021
(86) PCT No.: PCT/GB2021/051107

§ 371 Date: Nov. 4, 2022

(30) Foreign Application Priority Data
May 7, 2020 (GB) 2006749.2

(51) Int. Cl. H01M 10/0562; C01G 25/00; H01M 10/0525

(52) U.S. Cl. CPC H01M 10/0562; C01G 25/006; H01M 10/0525; C01P 2002/30; C01P 2002/76; C01P 2002/52; C01P 2006/40; C01P 2002/72; C01P 2002/74; C01P 2004/03; H01M 2300/0071

(57) ABSTRACT

A method of preparing a lithium lanthanum zirconate (LLZO) cubic garnet material is provided which comprises the following steps: (a) milling a slurry comprising one or more precursor compounds in an aqueous medium, wherein the one or more precursor compounds comprise lithium, lanthanum, zirconium and optionally one or more dopant elements, to provide a milled slurry; (b) spray drying the milled slurry to provide a spray-dried powder; and (c) annealing the spray-dried powder. The resultant LLZO cubic garnet material may be used as a lithium ion conductive solid electrolyte in secondary lithium-ion batteries.

### FIELD OF THE INVENTION

The present invention relates to ion-conductive ceramic materials, processes for preparing ion-conductive ceramic materials and electronic devices comprising the materials.

### BACKGROUND OF THE INVENTION

Rechargeable or “secondary” lithium-ion batteries require the presence of a lithium ion conductive electrolyte interposed between two electrodes. Solid ion conducting electrolytes are often desirable due to their stability, high energy density and long life, among other benefits.

One promising category of Li-ion conductive solid electrolytes is materials having the garnet-like structure described by Thangadurai et al. (“Novel Fast Lithium Ion Conduction in Garnet-Type Li₅La₃M₂O₁₂ (M=Nb, Ta)”, J. Am. Ceram. Soc. 86, 437-440, 2003). Such materials were found to have better Li-ion conductivity than earlier solid Li-ion conductors.

US 2010/203383 A1 describes an alternative garnet-like material for use as a Li-ion conductor based on the presence of Zr. Such materials include lithium lanthanum zirconium oxide (LLZO), for example having the composition Li₇La₃Zr₂O₁₂. The materials are made by the solid-state reaction of appropriate precursor salts or oxides. Such processes are energy intensive and scaling up the process to a commercially useful level is often not feasible. Furthermore, the reaction conditions used during solid state synthesis and subsequent calcination processes tend to lead to the volatilisation of lithium, causing a loss of stoichiometric control.

There is a need for alternative methods of production of LLZO which are more efficient, more easily scalable and provide a material with high Li-ion conductivity. The present invention has been developed with the above problems in mind.

### SUMMARY OF THE INVENTION

A first aspect of the invention is a method of preparing a lithium lanthanum zirconate cubic garnet (LLZO) material comprising the following steps:
(a) milling a slurry comprising one or more precursor compounds in an aqueous medium, wherein the one or more precursor compounds comprise lithium, lanthanum, zirconium and optionally one or more dopant elements, to provide a milled slurry;
(b) spray drying the milled slurry to provide a spray dried powder; and
(c) annealing the spray dried powder.

Known methods of preparing LLZO typically use solid state synthesis which may require treatment at very high temperature and/or multiple annealing or grinding steps to obtain a product containing the desired LLZO phase. By contrast the present invention provides a method in which an aqueous slurry is milled, spray dried and annealed to obtain the desired product. This offers a significant reduction in energy requirements and therefore manufacturing cost, allowing the process to be easily scaled up to prepare LLZO on a commercial scale. In addition, the LLZO product of the process of the invention has suitably high lithium conductivity.

Furthermore, known methods of LLZO preparation typically involve the heat treatment of precursor materials and/or the use of fine precursor particles with a homogeneous particle size distribution. The present inventors have found that precursor materials which have not been subjected to any pre-treatment may be successfully used in the current process, and in addition that large and inhomogeneously distributed precursor particles may be utilised without detriment, further enhancing process efficiency and reducing cost of production.

A further benefit of the invention is that limited chemical waste is generated from the aqueous milling step, providing a process which is more efficient and environmentally friendly.

A second aspect of the invention is a method of making a lithium lanthanum zirconate cubic garnet sintered body comprising the following steps:
(a) milling a slurry comprising one or more precursor compounds in an aqueous medium, wherein the one or more precursor compounds comprise lithium, lanthanum, zirconium and optionally one or more dopant elements, to provide a milled slurry;
(b) (i) spray drying the milled slurry to provide a spray dried powder;
   (ii) loading the spray dried powder into a mould; and
(c) annealing the spray dried powder.

Such a process combines the annealing and formation of a sintered body into a single step. In other words, the spray-dried powder is directly sintered to create a sintered body, without a preliminary annealing step. It has been found that, for a given annealing temperature, the density of the sintered body is higher when made by this single-step process compared with a sintered body made by first annealing the spray-dried powder followed by subsequent loading into a mould for a secondary annealing step. A higher density of the sintered body results in better ion conductivity due to lower grain boundary resistance, and lower annealing temperature is desirable due to decreased manufacturing costs and environmental considerations.

A third aspect of the invention is a lithium lanthanum zirconate cubic garnet material obtained or obtainable by a process according to the first aspect.

A fourth aspect of the invention is a lithium lanthanum zirconate cubic garnet sintered body obtained or obtainable by a process according to the second aspect.

A fifth aspect of the invention is a method of preparing a lithium lanthanum zirconate cubic garnet (LLZO) spray-dried precursor material comprising the following steps:
(i) milling a slurry comprising one or more precursor compounds in an aqueous medium, wherein the one or more precursor compounds comprise lithium, lanthanum, zirconium and optionally one or more dopant elements, to provide a milled slurry; and
(ii) spray drying the milled slurry to provide a spray-dried powder.

### BRIEF DESCRIPTION OF THE DRAWINGS

FIG. 1 shows particle size distributions for the separate La, Zr and Al hydroxide precursor materials used as a source of metal elements in the synthesis of LLZO in embodiments of the invention, and a PSD for the mixture of Li, La, Zr and Al precursor hydroxides.

FIG. 2 shows particle size distributions for the mixture of Li, La, Zr and Al hydroxide precursor materials used as a source of metal elements in the synthesis of LLZO in embodiments of the invention before milling, and after milling for 65 hours and 130 hours respectively.

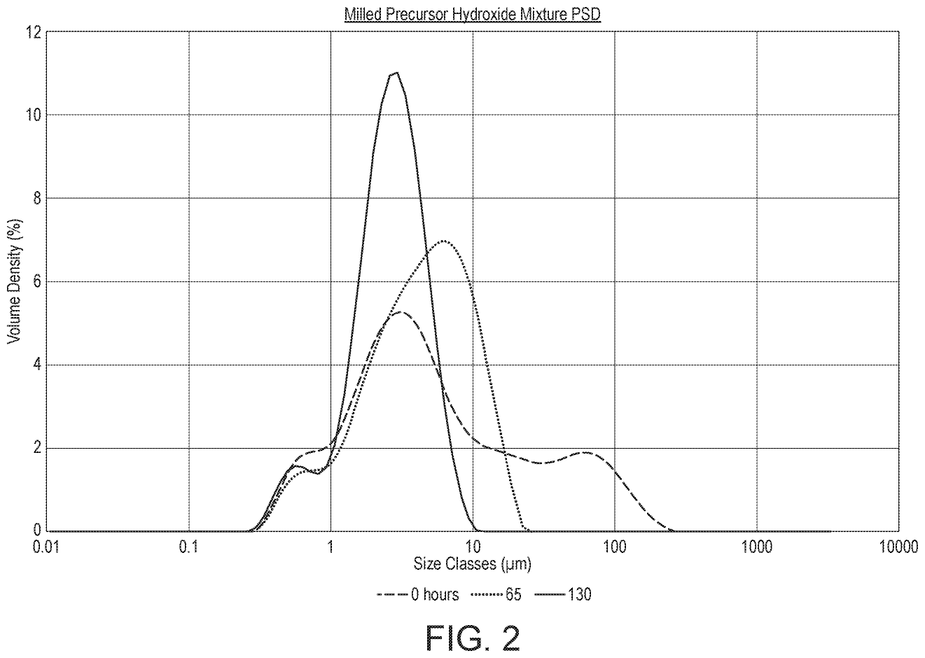

FIG. 3 shows PSD plots for (i) the spray-dried precursor material before annealing, (ii) the annealed product before milling, and (iii) the annealed and milled final product.

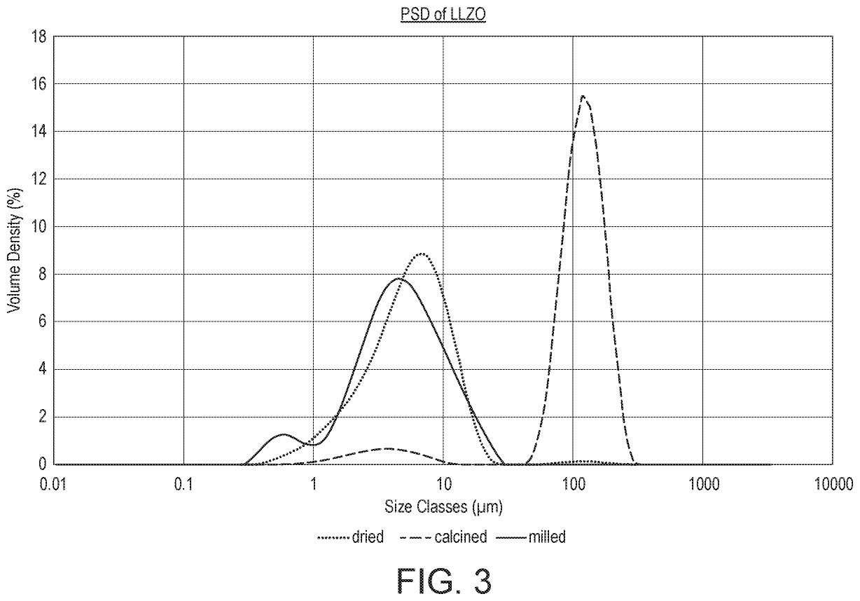

FIG. 4 shows the temperature profile used during X-ray diffraction analysis of milled and spray-dried precursor materials.

FIG. 5 shows an XRD contour plot for spray-dried precursor materials formed during an embodiment of the process of the invention.

FIG. 6 shows an XRD contour plot for spray-dried precursor materials formed during an embodiment of the process of the invention.

FIG. 7 shows XRD diffraction patterns for two LLZO products of the invention after annealing (plots (a) and (b)).

FIG. 8 shows an XRD contour plot for spray-dried precursor materials formed during an embodiment of the process of the invention.

FIG. 9 shows an XRD diffraction pattern for an LLZO product of the invention after annealing.

FIG. 10 shows an XRD diffraction pattern for an LLZO product of the invention after annealing.

FIG. 11 shows an XRD diffraction pattern for an LLZO product of the invention after annealing.

FIG. 12 shows (a) a Rietveld refinement of an XRD diffraction pattern for an LLZO product of the invention after annealing, and (b) an enlarged version of the same spectrum.

FIG. 13 shows (a) a Rietveld refinement of an XRD diffraction pattern for an LLZO product of the invention after annealing, and (b) an enlarged version of the same spectrum.

FIG. 14 shows cross-sectional SEM images of a sintered LLZO material (a) formed from hydroxide precursor materials and (b) formed from oxide precursor materials.

### DETAILED DESCRIPTION

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise.

A first aspect of the invention is a method of preparing a lithium lanthanum zirconate cubic garnet (LLZO) material comprising the following steps:
(a) milling a slurry comprising one or more precursor compounds in an aqueous medium, wherein the one or more precursor compounds comprise lithium, lanthanum, zirconium and optionally one or more dopant elements, to provide a milled slurry;
(b) spray drying the milled slurry to provide a spray-dried powder; and
(c) annealing the spray-dried powder.

The method comprises milling a slurry comprising one or more precursor compounds in an aqueous medium, wherein the one or more precursor compounds comprise lithium, lanthanum, zirconium and optionally one or more dopant elements, to provide a milled slurry. In some embodiments the method additionally comprises a preliminary step of dispersing one or more precursor compounds comprising lithium, lanthanum, zirconium and optionally one or more dopant elements in an aqueous medium to provide a slurry.

Thus, in some embodiments the method of the first aspect comprises:
(a) dispersing one or more precursor compounds comprising lithium, lanthanum, zirconium and optionally one or more dopant elements in an aqueous medium to provide a slurry; and milling the slurry to provide a milled slurry;
(b) spray drying the milled slurry to provide a spray dried powder; and
(c) annealing the spray dried powder.

In some embodiments, the slurry comprises two or more precursor compounds in the aqueous medium. In some embodiments, the slurry comprises four precursor compounds comprising lithium, lanthanum, zirconium and a dopant element, respectively, in the aqueous medium. In some embodiments, the slurry comprises at least three precursor compounds: a first precursor compound comprising or consisting of a lithium-containing compound; a second precursor compound comprising or consisting of a lanthanum-containing compound; a third precursor compound comprising or consisting of a zirconium-containing compound and optionally a fourth precursor compound comprising or consisting of a dopant-containing compound.

In some embodiments, the slurry comprises a lithium-containing compound, a lanthanum-containing compound, a zirconium-containing compound and optionally one or more dopant-containing compounds in an aqueous medium.

The slurry comprises solid, i.e. undissolved material in the aqueous medium. This may be due to the intrinsic lack of solubility of one or more of the compounds within the material in the aqueous medium. Additionally, or alternatively, it may be due to the high concentration of soluble material present, which leads to saturation of the aqueous medium such that further dissolution is not possible and additional material present remains undissolved.

Herein, “soluble” indicates a solubility of at least 5 g/100 mL, for example at least 10 g/100 mL at 25° C. Herein, “insoluble” indicates a solubility of less than 0.10 g/100 mL, for example less than 0.05 g/100 mL, for example less than 0.02 g/100 mL at 25° C.

In some embodiments, the precursor compounds are selected from oxides, hydroxides, carbonates, nitrates, oxyhydroxides and hydrated forms thereof. In some embodiments, the precursor compounds are not subjected to a heat treatment before step (a). The present inventors have found that heat treatment of precursors is not required in order to form the desired LLZO material following steps (a)-(c) as set out herein, offering a significant reduction in energy requirements and therefore manufacturing cost.

The slurry comprises a precursor compound which contains lithium, i.e. a lithium-containing compound. The slurry may comprise a single type of lithium-containing compound or two or more different types of lithium-containing compound. The lithium-containing compound may be selected from a soluble or partially-soluble compound (e.g. salt) of lithium. In some embodiments, the lithium-containing compound is selected from lithium hydroxide (e.g. LiOH or LiOH.H₂O), lithium carbonate (Li₂CO₃), and hydrated forms thereof. In some embodiments the lithium-containing compound is lithium carbonate.

The slurry comprises a precursor compound which contains lanthanum, i.e. a lanthanum-containing compound. The slurry may comprise a single type of lanthanum-containing compound or two or more different types of lanthanum-containing compound. The lanthanum-containing compound may be selected from a soluble or partially-soluble compound (e.g. salt) of lanthanum. The lanthanum-containing compound may be selected from lanthanum oxide (La₂O₃), lanthanum hydroxide (La(OH)₃), lanthanum carbonate (La₂(CO₃)₃) and hydrated forms thereof. In some embodiments, the lanthanum-containing compound is selected from lanthanum hydroxide (La(OH)₃), lanthanum carbonate (La₂(CO₃)₃) and hydrated forms thereof. In some embodiments, the lanthanum-containing compound is lanthanum hydroxide.

The slurry comprises a precursor compound which contains zirconium, i.e. a zirconium-containing compound. The slurry may comprise a single type of zirconium-containing compound or two or more different types of zirconium-containing compound. The zirconium-containing compound may be selected from a soluble or partially-soluble compound (e.g. salt) of zirconium. The zirconium-containing compound may be selected from zirconium oxide (ZrO₂), zirconium hydroxide (Zr(OH)₄) and hydrated forms thereof. In some embodiments, the zirconium-containing compound is zirconium hydroxide.

In some embodiments, the zirconium-containing compound and/or the lanthanum-containing compound has a particle size distribution such that the D50>1 μm, such as a D50 between 1 and 30 μm. The present inventors have found that the use of fine particles (D50<1 μm) of precursors is not required in the herein described process providing cost benefits and process efficiency advantages associated with the avoidance of fine powder handling requirements. The term D50 as used herein refers to the median particle diameter of a volume-weighted distribution. The D50 may be determined by using a laser diffraction method (e.g. by suspending the particles in water and analysing using a Malvern Mastersizer 2000).

In some embodiments, the slurry comprises lithium carbonate, lanthanum hydroxide, zirconium hydroxide and optionally one or more dopant-containing compounds in an aqueous medium. In some embodiments, the precursor compounds in the slurry consist of lithium carbonate, lanthanum hydroxide, zirconium hydroxide and optionally one or more dopant-containing compounds.

One or more dopant elements may optionally be included in the aqueous slurry along with the one or more precursor compounds. In some embodiments, the dopant elements are selected from one or more of Al, Ga, In, Sc, Y, Ge, Si, W, Ta, Hf, Nb, Ca, Ba, Sr, Mg, Sb, Sn, Te, Cl and Br. In some embodiments, the dopant elements are selected from one or more of Al, Ga, Sc, Y, Si, W, Ta, Hf, Nb, Ca, Ba, Sr, Mg, Sb, Sn, Te, Cl and Br. In some embodiments, the dopant elements are selected from one or more of Al, Ga, W, Ta and Nb. In some embodiments, the dopant element is Al. In some embodiments, the one or more dopant elements are provided in one or more dopant-containing compounds (e.g. salts). In some embodiments, the one or more dopant-containing compounds are independently selected from oxides, hydroxides, carbonates, oxyhydroxides and nitrates of the one or more dopant elements. Where multiple dopant elements are provided in the slurry, these may be present in a single precursor compound or multiple different precursor compounds.

In some embodiments, the dopant-containing compound consists of a compound of a dopant element selected from Al, Ga, Si, W, Ta, Nb, Ca, Ba, Y, Sr, Mg, Sb, Sn, Cl and Br. In some embodiments, the dopant-containing compound consists of a compound of a dopant element selected from Al, Ga, W, Ta and Nb. In some embodiments, the dopant-containing compound consists of a compound of Al.

The presence of small quantities of one or more dopant elements may help to provide a more chemically stable cubic structure and/or tailored grain boundary effects.

In some embodiments, the slurry comprises lithium carbonate, lanthanum hydroxide, zirconium hydroxide and one or more dopant-containing compounds in an aqueous medium. In some embodiments, the slurry comprises or consists of lithium carbonate, lanthanum hydroxide, zirconium hydroxide and one dopant-containing compound in an aqueous medium. In some embodiments, the slurry comprises or consists of lithium carbonate, lanthanum hydroxide, zirconium hydroxide and an aluminium-containing compound in an aqueous medium. The use of lanthanum hydroxide and zirconium hydroxide precursors offers improvements to process efficiency such as a reduction in the annealing temperature and/or time required to form the desired LLZO phase, a reduction in particle size formed during the annealing step, and improved sintering of the annealed powder.

Alternatively, two or more of lithium, lanthanum, zirconium and dopant element(s) may be provided within a single precursor compound, for example a mixed hydroxide precursor compound containing at least two different metals.

The slurry comprises the precursor compounds dispersed in an aqueous medium. In some embodiments, the slurry consists of the precursor compounds dispersed in the aqueous medium.

In some embodiments, the aqueous medium comprises greater than 50 wt % water, for example greater than 60 wt %, greater than 70 wt %, greater than 80 wt %, greater than 90 wt %, greater than 95 wt % or greater than 99 wt %, based on the total weight of the aqueous medium. In some embodiments, the aqueous medium is water, for example deionized water. This provides a more efficient and environmentally friendly process since the aqueous medium contains only water, which is easily removed during spray drying and annealing, and contains no additional solvents which would require more careful disposal. It may be preferred that the aqueous medium does not contain ammonia or an ammonium salt. This provides advantages associated with simplification of the treatment of waste streams from the process, and the use of ammonia and/or ammonium has been found by the present inventors not to be required for the formation of the desired LLZO phase using the process as set out herein, including with the use of lithium carbonate and/or lithium hydroxide. By “does not contain” it is meant herein that no ammonia or ammonia salts are intentionally added to the aqueous medium and this does not exclude the presence of impurity levels present in the starting materials. In some embodiments, the aqueous medium consists essentially of water. In some embodiments, the aqueous medium consists of water (although the presence of small quantities of impurities are not excluded).

In addition to the precursor compounds, the aqueous medium may also comprise one or more additives, stabilisers or dispersants, for example one or more surfactants. Without wishing to be bound by theory, the presence of such stabilisers or dispersants may aid in producing a smaller particle size more rapidly during the milling step.

The method comprises milling a slurry comprising the compounds in the aqueous medium.

In some embodiments, the method comprises a preliminary step, prior to step (a), of dispersing one or more precursor compounds comprising lithium, lanthanum, zirconium and optionally one or more dopant elements in an aqueous medium to provide a slurry.

Herein, “dispersing” denotes the act of bringing into contact a liquid phase and a solid phase to form a suspension or slurry, wherein some of the solid phase may become dissolved within the liquid phase but some of the solid phase remains undissolved. In some embodiments, the precursor compounds are added to the aqueous medium without any agitation of the slurry prior to the milling step, since the milling itself provides homogeneous mixing.

The aqueous medium may be added to a suitable vessel before the addition of the precursor compounds. The liquid component and each of the one or more precursor compounds may be added in any order to form the slurry. It is possible to ensure at least some undissolved material in the slurry based on the saturation point of the aqueous medium and/or the solubility of the precursor compounds.

In some embodiments, the amount of one or more precursor compounds added to the aqueous medium is from 5 wt % to 50 wt %, based on the total weight of the aqueous medium and precursor compounds, for example from 5 wt % to 45 wt %, 5 wt % to 40 wt %, 10 wt % to 40 wt %, 15 wt % to 40 wt %, 20 wt % to 40 wt %, 20 wt % to 35 wt %, 25 wt % to 35 wt % or about 30 wt %.

The aqueous slurry comprises an aqueous medium as a liquid component, and one or more precursor compounds comprising lithium, lanthanum, zirconium and optionally one or more dopant elements as a solid (dispersed) component. One or more of the precursor compounds may also be fully or partially dissolved in the liquid component of the slurry. In some embodiments, the slurry comprises or consists of the aqueous medium, a lithium-containing compound, a lanthanum-containing compound, a zirconium-containing compound and optionally one or more dopant-containing compounds. In some embodiments, the slurry comprises or consist of the aqueous medium, a lithium-containing compound, a lanthanum-containing compound, a zirconium-containing compound and one or more dopant-containing compounds. In some embodiments, the slurry comprises or consists of the aqueous medium, a lithium-containing compound, a lanthanum-containing compound, a zirconium-containing compound and a dopant-containing compound. In some embodiments, the slurry comprises or consists of the aqueous medium, a lithium-containing compound, a lanthanum-containing compound, a zirconium-containing compound and an aluminium-containing compound.

In some embodiments, the slurry consists of the aqueous medium and one or more precursor compounds comprising lithium, lanthanum, zirconium and optionally one or more dopant elements.

In some embodiments, the solid component is dispersed in the liquid component to provide a slurry with a solids content of from 5 wt % to 50 wt %, based on the total weight of the aqueous medium and precursor compounds in the slurry, for example from 5 wt % to 45 wt %, 5 wt % to 40 wt %, 5 wt % to 35 wt %, 5 wt % to 30 wt % or from 10 wt % to 30 wt %.

The method involves milling the above-described slurry to provide a milled slurry. As defined herein, milling is a process involving mixing of the slurry and reduction of the particle size of the one or more precursor compounds. The milling may be achieved by any suitable milling method such as ball milling, attritor milling, high shear mixing (for example using a Silverson L4RT or Ultra-turrax mixer) or homogenization (for example using a homogenizer such as a Microfluidics M110-P).

In some embodiments, milling of the slurry comprises ball-milling. In some embodiments, milling of the slurry comprises the addition of a grinding medium to the slurry, for example milling beads, followed by milling.

In some embodiments, milling beads are added to the slurry and the slurry is milled on a roller mill. The milling beads may be made from any suitable material. In some embodiments, the milling beads are zirconate milling beads, for example yttrium stabilized zirconia (YSZ) milling beads.

The milling beads may have a diameter of at least 1 mm, for example at least 2 mm, at least 3 mm, at least 4 mm or at least 5 mm. The milling beads may have a diameter of up to 20 mm, for example up to 15 mm or up to 10 mm. The milling beads may have a diameter of from 1 mm to 20 mm, for example from 2 mm to 20 mm, from 2 mm to 15 mm, from 3 mm to 15 mm, from 4 mm to 15 mm or from 5 mm to 10 mm.

Without wishing to be bound by theory, such milling bead sizes may contribute to providing more rapid break-up of the precursor compounds during milling.

In some embodiments, the milling beads comprise multiple sets of beads of different diameters. In some embodiments, the milling beads comprise a mixture of a first set of beads of 5 mm diameter and a second set of beads of 10 mm diameter.

In some embodiments, milling is performed until a substantially homogeneous slurry is provided.

In some embodiments, milling is performed for at least 10 minutes, for example at least 15 minutes, at least 30 minutes, at least 1 hour, at least 2 hours, at least 5 hours, at least 10 hours, at least 15 hours, at least 20 hours, at least 25 hours, at least 30 hours, at least 35 hours, at least 40 hours, at least 45 hours or at least 50 hours. In some embodiments, milling is performed for up to 150 hours, for example up to 120 hours, up to 100 hours, up to 95 hours, up to 90 hours, up to 85 hours, up to 80 hours, up to 75 hours or up to 70 hours. In some embodiments, milling is performed for a period of from 5 to 150 hours, for example from 5 to 120 hours, from 5 to 100 hours, from 10 to 90 hours, from 20 to 80 hours, from 30 to 80 hours, from 40 to 80 hours, from 50 to 80 hours, from 50 to 70 hours, or about 60 hours. In some embodiments, milling is performed for a period of from 10 minutes to 150 hours.

In some embodiments, the milling of the slurry comprises low-energy milling, for example milling with an energy of from about 100 to about 7000 Wh (Watt-hours) per litre of slurry, for example from about 200 to about 7000 Wh/L, 100 to about 4000 Wh/L, 200 to about 4000 Wh/L, 300 to about 4000 Wh/L or from about 100 to about 2000 Wh/L or 400 to about 2000 Wh/L.

The method involves spray drying the milled slurry to provide a spray dried powder.

Suitable spray drying techniques and apparatus are known to the skilled person. In some embodiments a fluid flow rate of from about 5 mL/min to about 15 mL/min is used during spray drying, for example from about 6 mL/min to about 14 mL/min, from about 7 mL/min to about 13 mL/min, from about 8 mL/min to about 12 mL/min, or about 10 mL/min.

In some embodiments a nozzle gas flow rate of from about 5 L/min to about 15 L/min is used during spray drying, for example from about 6 L/min to about 14 L/min, from about 7 L/min to about 13 L/min, from about 8 L/min to about 12 L/min, or about 10 L/min.

The inlet temperature during spray drying may be from about 150° C. to about 250° C., for example from about 160° C. to about 240° C., from about 170° C. to about 240° C., from about 180° C. to about 240° C., from about 190° C. to about 240° C., from about 200° C. to about 240° C., from about 210° C. to about 230° C., or about 220° C.

The solids content of the slurry which is fed to the spray dryer is preferably from about 150 g/L to about 250 g/L, for example from about 160 g/L to about 240 g/L, from about 170 g/L to about 230 g/L, from about 180 g/L to about 220 g/L, from about 190 g/L to about 210 g/L, or about 200 g/L.

A suitable spray dryer is the Buchi B290 spray dryer.

This step of the method may further comprise forming the spray dried powder into a shaped body (for example a pellet or sheet), such as by loading the spray-dried powder into a mould or die. In this way a suitably shaped green compact body may be provided which is subsequently annealed to produce a sintered body. For example, the mould or die may be shaped to provide a pellet.

In some embodiments, the spray-dried powder is loaded into a saggar or mould as a loose powder. In other embodiments, the spray-dried powder is formed into a shaped body, such as a pellet or sheet by pressing. In some embodiments, the spray-dried powder is shaped to provide a shaped body in a process comprising one or more of tape-casting, slot-die, screen printing and thin-layer deposition.

In some embodiments, the outlet of the spray dryer feeds the spray-dried powder directly into a die or mould.

In some embodiments, after spray drying and before annealing, the spray-dried powder is pressed to provide a densified green compact body. In some embodiments, the powder is pressed by applying a pressure of at least 1 ton, for example at least 2 tons, at least 3 tons, at least 4 tons or at least 5 tons.

After spray drying of the milled slurry, and optionally formation of a shaped body, the method of the first aspect comprises annealing or sintering the spray-dried powder to provide the LLZO product.

In some embodiments, the annealing step comprises heating the powder to a temperature of at least 500° C., for example at least 550° C., at least 600° C., at least 650° C. or at least 700° C. In preferred embodiments, the annealing comprises heating the powder to a temperature of at least 730° C.

In some embodiments, the annealing comprises heating the powder to a temperature of up to 1200° C., for example up to 1150° C., up to 1100° C., up to 1050° C., up to 1000° C., up to 950° C. or up to 900° C. In preferred embodiments, the annealing comprises heating the powder to a temperature of up to 800° C., for example less than 800° C., for example up to 790° C., up to 780° C., up to 770° C., up to 760° C. or up to 750° C. It has been found that in the process of the invention, that a product with the desired LLZO phase having good lithium ion conductivity is obtainable even when such relatively low annealing temperatures are employed, thereby providing a more energy efficient, scalable process. Furthermore, the relatively low annealing temperature increases the stoichiometric control of the process, since lithium volatilisation during annealing is minimised.

In some embodiments, the annealing comprises heating the powder to a temperature of from 500° C. to 1200° C., for example from 550° C. to 1150° C., from 600° C. to 1100° C., from 650° C. to 1050° C., from 700° C. to 1000° C., from 730° C. to 1000° C., from 730° C. to 950° C., from 730° C. to 900° C., from 730° C. to 850° C., from 730° C. to 800° C., from 500° C. to less than 800° C. or from 730° C. to 790° C.

The annealing step may be carried out for a period of at least 1 hour, for example at least 1.5 hours, at least 2 hours, at least 2.5 hours, at least 3 hours, at least 3.5 hours or at least 4 hours. Annealing may be carried out for a period of at least 5 hours.

It has surprisingly been found that when annealing is performed for at least 10 hours, in particular at least 11 hours, at least 12 hours or at least 13 hours, the product obtained has improved phase-purity. At shorter annealing times, some pyrochlore impurity phase is observed when the material is analysed by XRD. However, at such longer annealing times the XRD analysis shows that phase-pure lithium lanthanum zirconate cubic phase is formed, without the presence of any pyrochlore phase impurity, or with reduced levels of impurity, despite the use of only a single annealing step in the current process. As a result, in preferred embodiments annealing is performed for at least 10 hours, for example at least 11 hours, at least 12 hours or at least 13 hours. More preferably annealing is performed for at least 10 hours, for example at least 11 hours, at least 12 hours or at least 13 hours at a temperature of at least 900° C., for example at least 950° C., at least 1000° C. or at least 1030° C. Annealing may be performed for a period of from 10 to 15 hours, for example from 11 to 15 hours, from 11 to 14 hours, from 12 to 14 hours or from 13 to 15 hours, at a temperature of from 900° C. to 1200° C., for example from 950° C. to 1200° C., from 1000° C. to 1200° C., from 1000° C. to 1100° C. or from 1000° C. to 1050° C.

In some embodiments, the first aspect of the invention provides a method of preparing a lithium lanthanum zirconate cubic garnet material comprising the following steps:
(a) milling a slurry comprising one or more precursor compounds in an aqueous medium, wherein the one or more precursor compounds comprise lithium, lanthanum, zirconium and optionally one or more dopant elements, to provide a milled slurry;
(b) spray drying the milled slurry to provide a spray dried powder; and
(c) annealing the spray dried powder at a temperature of from 500° C. to 1200° C., preferably from 730° C. to 800° C.

In some embodiments, the annealing is performed in air which has been filtered to contain less than 0.1 ppm total hydrocarbons.

In some embodiments, the annealing is performed in dry, CO₂-free air (where “dry” denotes a moisture content of less than 10 ppm by weight, for example less than 5 ppm or less than 1 ppm). CO₂-free air denotes air with a CO₂ content of less than 5 ppm by weight, for example less than 4 ppm, less than 2 ppm or less than 1 ppm.

In some embodiments, the annealing is performed in an inert atmosphere. The inventors have found that the use of an inert atmosphere minimises corrosion of the crucibles in which the powder is held during the annealing process, thereby providing better control of the process and the final composition of the material, since contamination of the material by any products of crucible corrosion is minimised. In some embodiments, the inert atmosphere comprises one or more of N₂ and Ar. In some embodiments, the inert atmosphere comprises N₂. In some embodiments, the inert atmosphere comprises Ar.

In some embodiments, the method comprises only one annealing step (i.e. the annealing of step (c) after spray drying). This provides a more efficient and environmentally friendly process which nevertheless provides an LLZO product with the desired phase and with high ion conductivity.

The product of the annealing step is an LLZO material which may be used as an ion conductor in a variety of applications, for example as solid-state electrolytes. The LLZO material has very high ion conductivity and negligible electron conductivity. The LLZO material may find use as an ion conductor in applications selected from batteries (e.g. lithium ion secondary batteries), electrochromic systems, accumulators (e.g. supercapacitors), chemical sensors (e.g. gas sensors) and thermoelectric converters.

The LLZO material is a lithium lanthanum zirconate material which has a garnet-type structure or a structure close to the garnet-type. In some embodiments the LLZO material is a doped LLZO material, containing lithium, lanthanum, zirconium and one or more dopant elements. The LLZO material comprises lithium lanthanum zirconate cubic garnet, i.e. the cubic polymorph of LLZO garnet.

The chemical composition of the LLZO material which may be manufactured according to the present method is not particularly limited, provided that it comprises the cubic garnet-type structure, and the benefits of the invention (reduction in energy requirements and manufacturing cost, ease of scale-up, reduced level of chemical waste from the aqueous milling step) are obtained regardless of the specific chemical composition of the final product. The invention is therefore broadly applicable to the manufacture of any LLZO cubic garnet material. The stoichiometry and composition of the final product may be varied by varying the molar ratios of the precursor compounds added to the aqueous slurry.

In some embodiments, the LLZO material has a composition according to formula I:

Li_{7-w}AₐLa_{3-b}B_{b}Zr_{2-c}C_{c}O_{12-z}X_{z} (I)

wherein A is selected from Al, Ga, Zn, Be, Mg and Co;
B is selected from Ca, Ba, Sr, Rb, Y;
C is selected from Hf, Co, Si, W, Ta, Nb, Sb, Sn, Mg, Mn, Cr, Mo, Pt, Pd, Rh, Ir, Ca and Tc;
X is selected from Cl, Br and F;
0≤w≤1.5;
0≤a≤0.5;
0≤b≤0.6;
0≤c≤0.6; and
0≤z≤1;
wherein w, a, b, c and z are chosen to provide an overall composition which is charge-balanced.

In some embodiments, A is Al.

In some embodiments, 0≤w≤1.0. In some embodiments, 0.2≤w≤0.8, for example 0.3≤w≤0.8, 0.4≤w≤0.8, 0.5≤w≤0.8, 0.6≤w≤0.8, or 0.7≤w≤0.8.

In some embodiments, 0.2≤a≤0.3. In some embodiments, a is about 0.25.

In some embodiments, 0≤b≤0.5, for example 0≤b≤0.4, 0≤b≤0.3, 0≤b≤0.2 or b=0.

In some embodiments, 0≤c≤0.5, for example 0≤c≤0.4, 0≤c≤0.3, 0≤c≤0.2 or c=0.

In some embodiments, z=0.

In some embodiments, the LLZO material contains an LLZO phase which is represented by the formula Li_{6.25}Al_{0.25}La₃Zr₂O₁₂. The LLZO material may contain excess lithium which resides outside the LLZO phase, for example as lithium oxide (Li₂O). Thus in some embodiments the LLZO material contains an LLZO phase which is represented by the formula Li_{6.25}Al_{0.25}La₃Zr₂O₁₂, and a Li₂O phase. The molar ratio of (Li_{6.25}Al_{0.25}La₃Zr₂O₁₂) to (Li₂O) in the material may be from about 1:0.1 to 1:0.5.

Expressed as percentage by weight based on the total weight of the LLZO material, in some embodiments the lithium content of the LLZO material is from 4.0 to 7.0 wt %, for example from 4.1 to 6.9 wt %, from 4.2 to 6.8 wt %, from 4.5 to 6.5 wt %, from 4.6 to 6.4 wt %, from 5.0 to 6.0 wt %, or about 5.5 wt %.

Expressed as percentage by weight based on the total weight of the LLZO material, in some embodiments the lanthanum content of the LLZO material is from 45 to 55 wt %, for example from 46 to 54 wt %, from 47 to 53 wt %, from 48 to 52 wt %, from 49 to 51 wt %, or about 49.5 wt %.

Expressed as percentage by weight based on the total weight of the LLZO material, in some embodiments the zirconium content of the LLZO material is from 15 to 25 wt %, for example from 16 to 24 wt %, from 17 to 23 wt %, from 18 to 22 wt %, or about 21.5 wt %.

Expressed as percentage by weight based on the total weight of the LLZO material, in some embodiments the aluminium content of the LLZO material is from 0 to 1.5 wt %, for example from 0 to 1.2 wt %, from 0.5 to 1.5 wt %, from 0.5 to 1.2 wt %, from 0.5 to 1.0 wt %, or about 0.8 wt %.

The LLZO material may contain less than 1500 ppm of trace impurities. In some embodiments, any further metal elements other than Li, La, Zr or dopant element are present in a total amount of less than 2000 ppm by weight, for example less than 1500 ppm, less than 1200 ppm or less than 1000 ppm. In some embodiments, the LLZO material contains less than 1500 ppm trace impurity, including the elements Fe, Ti, Ca, Cr, Cl, P and F. In other words, if the LLZO material contains one or more of these elements, the total amount may be less than 1500 ppm. In some embodiments, the total amount of any one element present as a trace impurity is less than 500 ppm. In some embodiments, the total amount of any one element selected from Fe, Ti, Ca, Cr, Cl, P and F present as a trace impurity is less than 500 ppm.

In some embodiments, the LLZO material contains less than 0.5 wt % Li₂CO₃, for example less than 0.4 wt %, less than 0.3 wt %, or less than 0.2 wt %.

In some embodiments, the LLZO material contains less than 0.8 wt % LiOH, for example less than 0.7 wt %, less than 0.6 wt %, or less than 0.5 wt %.

In some embodiments, the LLZO material comprises:
from 4.0 to 7.0 wt % Li;
from 45 to 55 wt % La;
from 15 to 25 wt % Zr; and
from 0.5 to 1.5 wt % Al;
   based on the total weight of the LLZO material.

In some embodiments, the LLZO material comprises:
from 4.0 to 7.0 wt % Li;
from 45 to 55 wt % La;
from 15 to 25 wt % Zr; and
from 0 to 1.5 wt % Al;
   based on the total weight of the LLZO material; with any further metal elements being present in a total amount of less than 2000 ppm by weight, for example less than 1500 ppm, less than 1200 ppm or less than 1000 ppm.

In some embodiments, the LLZO material comprises:
from 4.0 to 7.0 wt % Li;
from 45 to 55 wt % La;
from 15 to 25 wt % Zr; and
from 0 to 1.5 wt % Al;
   based on the total weight of the LLZO material; with any further metal elements being present in a total amount of less than 2000 ppm by weight, for example less than 1500 ppm, less than 1200 ppm or less than 1000 ppm;
   wherein the LLZO material contains from 0 to 500 ppm Ti, from 0 to 200 ppm Fe, from 0 to 200 ppm Ca and from 0 to 200 ppm Cr.

In some embodiments, the LLZO material comprises:
about 5.5 wt % Li;
about 49.5 wt % La;
about 21.5 wt % Zr; and
about 0.8 wt % Al;
   based on the total weight of the LLZO material.

In some embodiments, the LLZO material is a particulate material.

The LLZO material may comprise the LLZO cubic garnet phase along with additional phases. One or more additional phases may be present. Additional phases may include phases such as La₂Zr₂O₇, Li₂CO₃ or La₂O₃. In some embodiments, the material made according to the process of the invention comprises at least 20 wt % LLZO cubic garnet phase, for example at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt % or at least 99 wt %, as determined using Rietveld refinement of a powder XRD spectrum. In some cases the methods of the invention provide a material which is 100% pure LLZO cubic garnet phase, i.e. containing no measurable additional phases.

The process may comprise one or more further milling steps after the annealing step, to further reduce the particle size of the final product. Such further milling step may comprise dry milling or wet (slurry) milling. Thus, in some embodiments, the first aspect comprises a method of preparing a lithium lanthanum zirconate cubic garnet material comprising the following steps:
(a) milling a slurry comprising one or more precursor compounds in an aqueous medium, wherein the one or more precursor compounds comprise lithium, lanthanum, zirconium and optionally one or more dopant elements, to provide a milled slurry;
(b) spray drying the milled slurry to provide a spray dried powder;
(c) annealing the spray dried powder to provide an annealed powder; and
(d) milling the annealed powder.

The LLZO material may have a specific surface area of from about 1.5 to about 2.5 m²/g, for example from about 1.6 to about 2.4 m²/g, from about 1.7 to about 2.3 m²/g, from about 1.8 to about 2.2 m²/g, from about 1.9 to about 2.1 m²/g, or about 2.0 m²/g.

In some embodiments, the LLZO material has a bulk density of from about 4.0 to about 6.0 g/cm³, for example from about 4.1 to about 5.9 g/cm³, from about 4.2 to about 5.8 g/cm³, from about 4.5 to about 5.5 g/cm³, from about 4.6 to about 5.4 g/cm³, from about 4.7 to about 5.3 g/cm³, or from about 4.8 to about 5.2 g/cm³.

The LLZO material may have a moisture content of less than about 500 ppm, for example less than about 450 ppm, less than about 400 ppm, less than about 350 ppm, less than about 300 ppm, less than about 250 ppm, less than about 200 ppm, less than about 150 ppm or less than about 120 ppm. In some embodiments the LLZO material has a moisture content of from about 50 ppm to about 500 ppm, for example from about 60 ppm to about 400 ppm, from about 70 ppm to about 300 ppm, from about 80 ppm to about 200 ppm, from about 80 ppm to about 120 ppm, or about 100 ppm.

In some embodiments the LLZO material, after spray drying and annealing, is a particulate material with a D50 particle size from about 10 to about 500 μm, for example from about 50 to about 400 μm, or from about 50 to about 200 μm. In some embodiments the LLZO material, after spray drying, annealing and further milling, is a particulate material with a D50 particle size from about 0.3 to about 10 μm, for example from about 1.0 to about 8.0 μm, or from about 2.0 to about 8.0 μm. Herein, “D50 particle size” represents the 50% intercept in the cumulative particle size distribution by volume, as measured by dynamic light scattering techniques (e.g. according to ASTM B822 of 2017) under the Mie scattering theory, using an instrument such as the Malvern Mastersizer.

In some embodiments the D10 particle size of the LLZO material, after spray drying and annealing, is from about 1.0 to about 100 μm, for example from about 1.0 to about 90 μm, from about 1.0 to about 80 μm, or from about 1.0 μm to about 10 μm. In some embodiments the D10 particle size of the LLZO material, after spray drying, annealing and further milling, is from about 0.05 to about 1.0 μm, for example from about 0.1 to about 1.0 μm, from about 0.2 to about 0.9 μm, or from about 0.2 μm to about 0.8 μm. Herein, “D10 particle size” represents the 10% intercept in the cumulative particle size distribution by volume, as measured by dynamic light scattering techniques (e.g. according to ASTM B822 of 2017) under the Mie scattering theory, using an instrument such as the Malvern Mastersizer.

In some embodiments the D99 particle size of the LLZO material, after spray drying and annealing, is from about 100 to about 500 μm, for example from about 150 to about 400 μm, from about 150 to about 300 μm, or from about 150 μm to about 250 μm. In some embodiments the D99 particle size of the LLZO material, after spray drying, annealing and further milling, is from about 10 to about 50 μm, for example from about 10 to about 40 μm, from about 10 to about 30 μm, or from about 15 to about 25 μm. Herein, “D99 particle size” represents the 99% intercept in the cumulative particle size distribution by volume, as measured by dynamic light scattering techniques (e.g. according to ASTM B822 of 2017) under the Mie scattering theory, using an instrument such as the Malvern Mastersizer.

In some embodiments, after spray drying, annealing and further milling, the LLZO material is a particulate material having a particle size distribution with a D10 of from about 0.05 μm to about 1.0 μm, a D50 of from about 1.0 μm to about 10 μm and a D99 of from about 1 μm to about 50 μm.

In some embodiments, after spray drying, annealing and further milling, the LLZO material is a particulate material having a particle size distribution with a D10 of from about 0.05 μm to about 1.0 μm, a D50 of from about 1.0 μm to about 10 μm and a D99 of from about 1 μm to about 50 μm; a bulk density of from about 4.0 to about 6.0 g/cm³; and a specific surface area of from about 1.5 to about 2.5 m²/g.

In some embodiments, after spray drying, annealing and further milling, the LLZO material is a particulate material having a particle size distribution with a D10 of from about 0.05 μm to about 1.0 μm, a D50 of from about 1.0 μm to about 10 μm and a D99 of from about 1 μm to about 50 μm; a bulk density of from about 4.0 to about 6.0 g/cm³; a specific surface area of from about 1.5 to about 2.5 m²/g and a moisture content of less than about 500 ppm.

A second aspect of the invention is a method of making a lithium lanthanum zirconate cubic garnet sintered body comprising the following steps:
(a) milling a slurry comprising one or more precursor compounds in an aqueous medium, wherein the one or more precursor compounds comprise lithium, lanthanum, zirconium and optionally one or more dopant elements, to provide a milled slurry;
(b) (i) spray drying the milled slurry to provide a spray dried powder;
   (ii) forming the spray-dried powder into a shaped body, for example by loading the spray dried powder into a mould; and
(c) annealing the spray dried powder.

All of the options and preferences described above in relation to the first aspect of the invention apply equally to this aspect.

The nature of the mould is not particularly limited and will be chosen based on the desired final geometry of the sintered body.

In some embodiments, the density of the sintered body is at least 3 g/cm³, for example at least 3.5 g/cm³, at least 4 g/cm³, at least 4.5 g/cm³ or at least 5 g/cm³. In some embodiments, the density of the sintered body is from 3 g/cm³ to 6 g/cm³, for example from 4 g/cm³ to 6 g/cm³, from 4.5 g/cm³ to 6 g/cm³, from 4.5 g/cm³ to 5.5 g/cm³, from 5 g/cm³ to 5.5 g/cm³ or about 5.2 g/cm³.

An aspect of the invention is a method of preparing a lithium lanthanum zirconate cubic garnet (LLZO) spray-dried precursor material comprising the following steps:
(i) milling a slurry comprising one or more precursor compounds in an aqueous medium, wherein the one or more precursor compounds comprise lithium, lanthanum, zirconium and optionally one or more dopant elements, to provide a milled slurry; and
(ii) spray drying the milled slurry to provide a spray dried powder.

The spray-dried LLZO precursor material product of this process is a useful intermediate in the preparation of an LLZO material. The spray-dried LLZO precursor material may be subjected to a subsequent annealing step to prepare an LLZO material. All of the options and preferences described above in relation to the first aspect of the invention apply equally to this aspect.

An aspect of the invention is an electronic device comprising a solid-state electrolyte comprising an LLZO material manufactured according to the process of the invention. In some embodiments, the electronic device is selected from a battery (e.g. lithium ion secondary battery), electrochromic system, accumulator (e.g. supercapacitor), chemical sensor (e.g. gas sensor) and thermoelectric converter. In some embodiments, the electronic device is a secondary lithium-ion battery.

### EXAMPLES

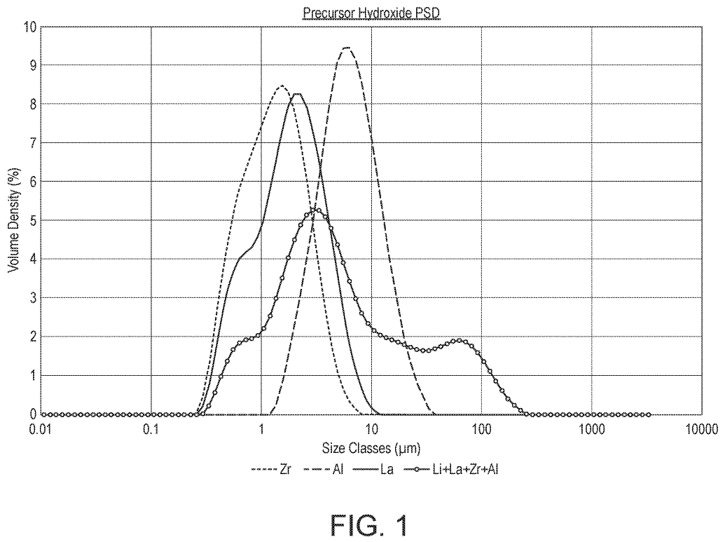

The precursor materials used in the synthesis methods described herein were used as received from commercial suppliers without any heat treatment or other treatment prior to formation of the aqueous slurry. FIG. 1 shows the particle size distribution of the hydroxide precursors used in the synthesis methods A and B which indicates that the zirconium, lanthanum and aluminium hydroxides each had a D50 in the range 1 to 10 μm, with an overall inhomogeneous distribution of precursor particle sizes.

Synthesis Method A

The quantities of the precursors as set out in Table 1 were mixed with 120 g of 10 mm diameter YSZ balls and 60 g of 5 mm diameter YSZ balls. The precursors and milling balls were added to a 300 mL polypropylene bottle and deionised water was added to yield a total volume (including milling balls) of 150 mL.

The mixture was gently rolled on a roller bed (setting 4, 90 rpm, 60 Wh/L energy input) for the period of time set out in Table 1. The mixture was then filtered to remove the milling balls before being heated to boiling to evaporate excess liquid, with the total volume after heating being indicated in Table 1. The mixture was then left to stir for 3 days.

The mixture was then spray dried using a Buchi mini spray dryer with the following process parameters: 200° C. inlet temperature, 130° C. outlet temperature, 100% aspirator flow, 30% pump flow, 3 nozzle cleaner, −60 mbar filter pressure.

A pellet weighing 0.5 g was formed from the spray-dried material, pressed at 10 ton and annealed under the conditions indicated in Table 1.

TABLE 1

Example

| | | 1 | 2 | 3 |
|---|---|---|---|---|
| Precursor | LiOH | 2.796 | 0 | 0 |
| masses (g) | Li₂CO₃ | 0 | 3.477 | 2.922 |
| | La₂O₃ | 7.110 | 7.249 | 0 |
| | La(OH)₃ | 0 | 0 | 7.104 |
| | ZrO₂ | 3.422 | 3.656 | 0 |
| | Zr(OH)₄ | 0 | 0 | 3.971 |
| | CaCO₃ | 0.405 | 0 | 0 |
| | Nb₂O₅ | 0.527 | 0 | 0 |
| | Al₂O₃ | 0.189 | 0.189 | 0 |
| | Al(OH)₃ | 0 | 0 | 0.243 |

| | | | |
|---|---|---|---|
| Milling time (hrs) | 70 | 70 | 70 |
| Total volume (mL) | 150 | 150 | 125 |
| Annealing temp (° C.) | 1000 | 1000 | 1000 |
| Annealing time (hrs) | 2 | 2 | 2 |

Synthesis Method B

The quantities of the precursors as set out in Table 2 were mixed with 600 g of 10 mm diameter YSZ balls and 300 g of 5 mm diameter YSZ balls. The precursors and milling balls were added to a 2000 mL polypropylene bottle and deionised water was added to yield a slurry volume (including milling balls) as indicated in Table 2.

The mixture was gently rolled on a roller bed (setting 4, 90 rpm, 60 Wh/L energy input) for the period of time set out in Table 2.

The mixture was then spray dried using a Buchi mini spray dryer with the following process parameters: 220° C. inlet temperature, 130° C. outlet temperature, 100% aspirator flow, 30% pump flow, 3 nozzle cleaner, −60 mbar filter pressure.

Samples of the spray-dried were collected for X-ray diffraction analysis (see below).

A pellet weighing 0.7 g was formed from the spray-dried material, pressed at 10 ton and annealed under the conditions indicated in Table 2 in a crucible under an N₂ atmosphere.

TABLE 2

| | | Example | | | | | | | |
|---|---|---|---|---|---|---|---|---|---|
| | | 4 | 5 | 6 | 7 | 8 | 9 | 10 | 11 |
| Precursor | LiOH | 0 | 32.722 | 0 | 0 | 0 | 0 | 0 | 0 |
| masses (g) | LiOH•H₂O | 32.887 | 0 | 31.394 | 31.394 | 35.833 | 35.833 | 35.833 | 35.833 |
| | La(OH)₃ | 57.490 | 57.202 | 67.476 | 67.476 | 71.305 | 71.305 | 71.305 | 71.305 |
| | Zr(OH)₄ | 37.080 | 36.894 | 37.718 | 37.718 | 39.858 | 39.858 | 39.858 | 39.858 |
| | CaCO₃ | 4.755 | 4.731 | 0 | 0 | 0 | 0 | 0 | 0 |
| | Al(OH)₃ | 3.354 | 3.337 | 3.411 | 3.411 | 3.004 | 3.004 | 3.004 | 3.004 |

| | | | | | | | | |
|---|---|---|---|---|---|---|---|---|
| Milling time (hrs) | 70 | 70 | 87 | 161 | 70 | 134 | 136 | 111 |
| Slurry volume (mL) | 750 | 750 | 700 | 700 | 1000 | 1000 | 1000 | 1000 |
| Annealing temp (° C.) | 1000 | 1000 | 1000 | 1000 | 1050 | 1050 | 1050 | 1050 |
| Annealing time (hrs) | 2 | 2 | 2 | 2 | 5 | 5 | 5 | 5 |

| | | Example | | | | | | | | | |
|---|---|---|---|---|---|---|---|---|---|---|---|
| | | 12 | 13 | 14 | 15 | 16 | 17 | 18 | 19 | 20 | 21 |
| Precursor | LiOH | 0 | 0 | 0 | 0 | 0 | 0 | 0 | 0 | 0 | 0 |
| masses (g) | LiOH•H₂O | 35.833 | 35.833 | 35.833 | 35.833 | 35.344 | 35.790 | 35.833 | 31.394 | 35.833 | 35.833 |
| | La(OH)₃ | 71.305 | 71.305 | 71.305 | 71.305 | 69.109 | 69.981 | 71.305 | 67.476 | 71.305 | 71.305 |
| | Zr(OH)₄ | 39.858 | 39.858 | 39.858 | 39.858 | 39.963 | 40.467 | 39.858 | 37.718 | 39.858 | 39.858 |
| | CaCO₃ | 0 | 0 | 0 | 0 | 0 | 0 | 0 | 0 | 0 | 0 |
| | Al(OH)₃ | 3.004 | 3.004 | 3.004 | 3.004 | 3.012 | 3.050 | 3.004 | 3.411 | 3.004 | 3.004 |
| | RbOH (50% in | 0 | 0 | 0 | 0 | 2.572 | 0 | 0 | 0 | 0 | 0 |
| | H₂O) | | | | | | | | | | |
| | KOH | 0 | 0 | 0 | 0 | 0 | 0.713 | 0 | 0 | 0 | 0 |
| | NaOH | 0 | 0 | 0 | 0 | 0 | 0 | 0 | 0 | 0 | 0 |
| | Y₂(CO₃)₃•H₂O | 0 | 0 | 0 | 0 | 0 | 0 | 0 | 0 | 0 | 0 |

| | | | | | | | | | | |
|---|---|---|---|---|---|---|---|---|---|---|
| Milling time (hrs) | 106 | 106 | 106 | 106 | 106 | 106 | 106 | 161 | 134 | 134 |
| Slurry volume (mL) | 1000 | 1000 | 1000 | 1000 | 1000 | 1000 | 1000 | 700 | 1000 | 1000 |
| Annealing temp (° C.) | 1050 | 1050 | 1050 | 1050 | 1050 | 1050 | 1030 | 1030 | 1000 | 1000 |
| Annealing time (hrs) | 5 | 5 | 5 | 5 | 5 | 5 | 5 | 13 | 5 | 10* |

*two consecutive 5-hour annealing stages at 1000° C., with cooling under zero-air between the two stages

X-Ray Diffraction Studies

The spray-dried samples (prior to annealing) collected in Examples 1, 2 and 3 were studied by variable temperature X-ray diffraction analysis. A Bruker D8 Advance diffractometer was used fitted with an Anton Paar XRK 900N heating cell for in situ measurements. The diffractometer included a Vantec PSD detector. Bruker AXS Diffrac Eva V4 software (2010-2016) was used for phase identification. The following parameters were used during the measurements:

| | |
|---|---|
| Optic | 60 mm Goebel mirror |
| Radiation | Cu K_{α} (λ = 1.5406 + 1.54439 Å) |
| Scan range | 11-60° 2θ |
| Step size | 0.027° |
| Scan rate | 0.54 s/step |
| Tube voltage and current | 40 kV, 40 mA |
| Temperature | Ambient to 890° C. |

Samples were heated and cooled under N₂ to investigate phase transformation. A loose powder sample was loaded into a sample boat and mounted in the heating chamber under a flow of N₂. An initial “as received” long data set was measured between 2θ=11° and 2θ=130° with a step size of 0.022° and a scan rate of 1 s/step was collected at room temperature for reference.

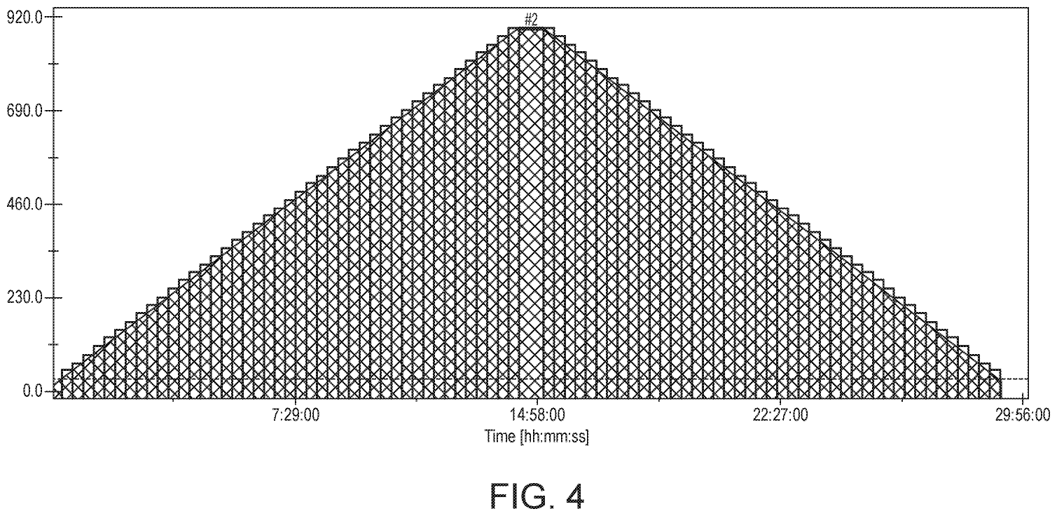

Data was then continuously collected using the parameters set out in the table above between 2θ=11° and 20=60° while heating from 30 to 890° C. at 1° C./min. The heating profile during the main phase of data collection is shown in FIG. 4. At 890° C. the sample was held and a longer scan was collected. After that, samples were cooled from 890 to 30° C. at 1° C./min. After cooling another long data set was measured between 2θ=10° and 2θ=130° with a step size of 0.022° and a scan rate of 1 s/step.

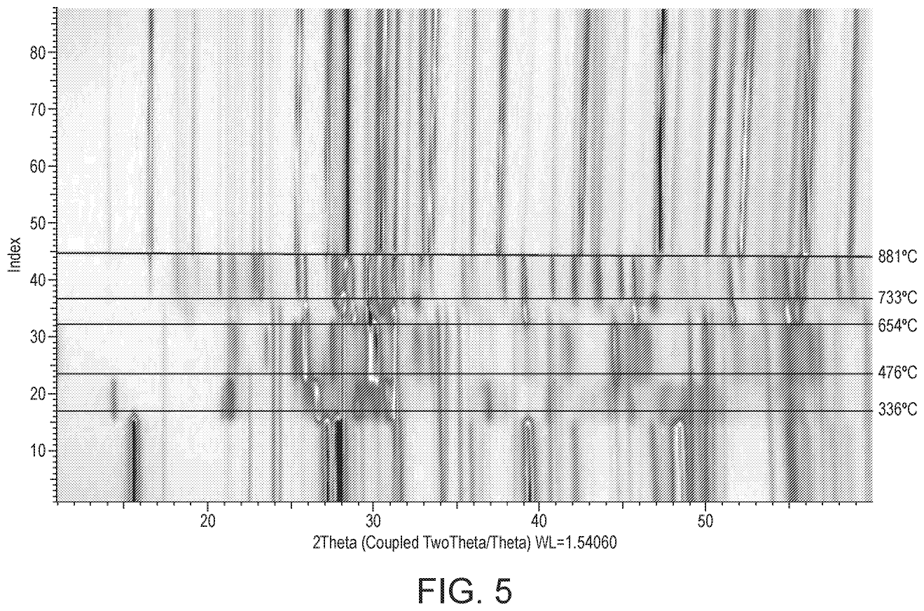

An XRD contour plot for the sample of Example 1 during the temperature increase is shown in FIG. 5. The contour plot shows the loss of the La(OH)₃ phase at around 336° C., the formation of a major Li_{0.3}La₂(CO₃)_{0.85}O_{2.3} phase at around 476° C. which is subsequently lost at around 654° C., and the sudden formation of cubic Li₇La₃Zr₂O₁₂ phase at around 881° C.

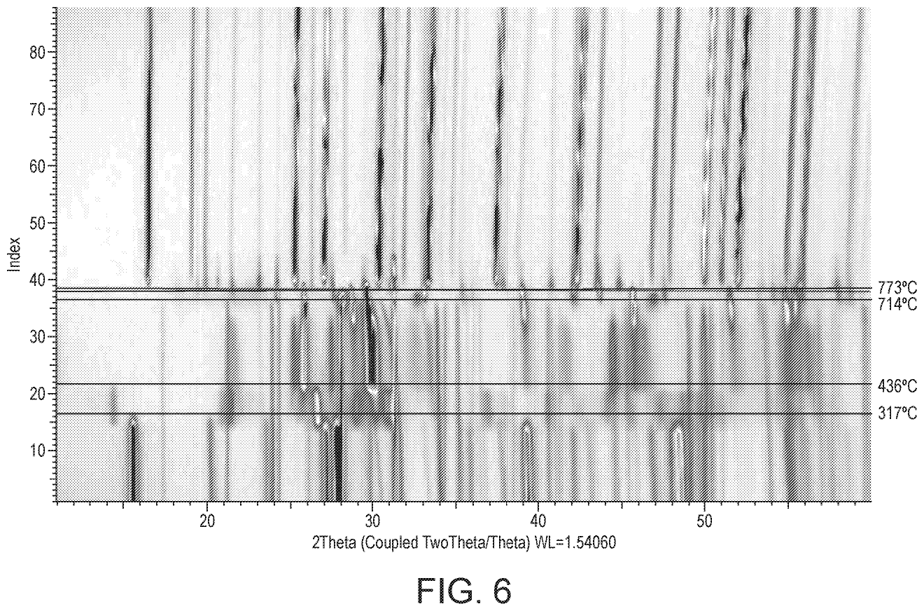

An XRD contour plot for the sample of Example 2 during the temperature increase is shown in FIG. 6. The contour plot shows the loss of the La(OH)₃ phase at around 317° C., the formation of a major Liₐ₃La₂(CO₃)_{0.85}O_{2.3} phase at around 436° C. which is subsequently lost at around 654° C., and the sudden formation of cubic Li₇La₃Zr₂O₁₂ phase at around 773° C.

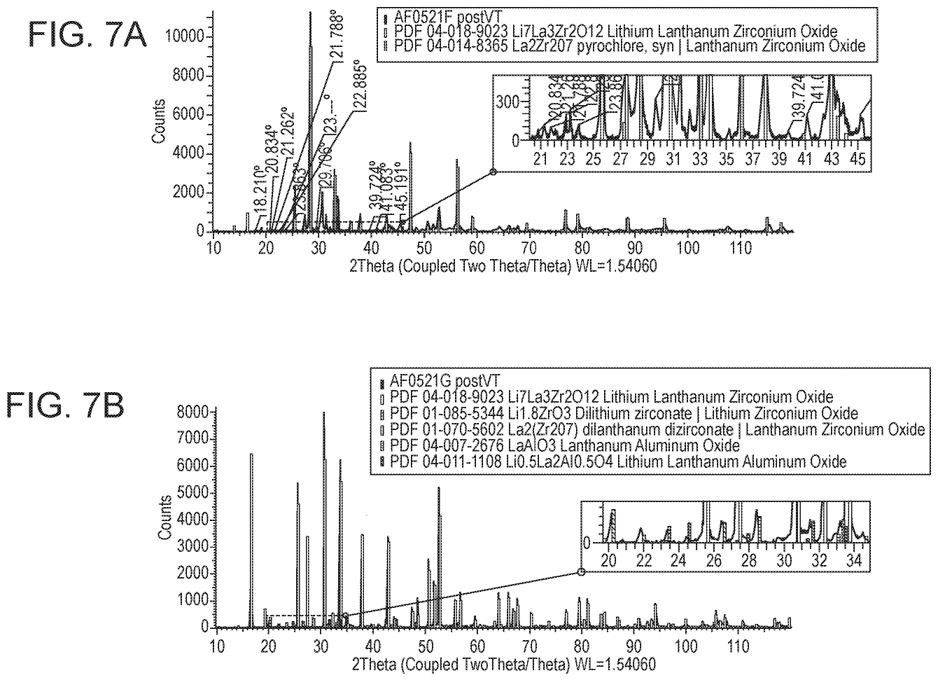

FIG. 7 shows the diffraction patterns of (a) Example 1 and (b) Example 2 after the experiment, each showing the presence of the Li₇La₃Zr₂O₁₂ phase.

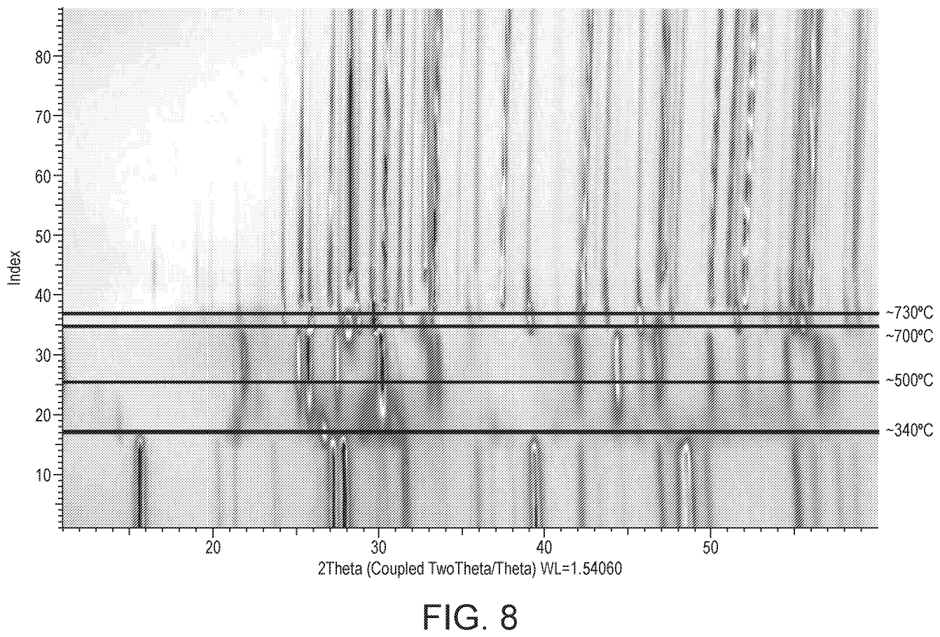

An XRD contour plot for the sample of Example 3 during the temperature increase is shown in FIG. 8. The contour plot shows the loss of the precursor La(OH)₃, LaCO₃OH and Li₂CO₃ phases at around 340° C., and the formation of cubic Li₇La₃Zr₂O₁₂ phase at around 730° C. This data indicates that the use of hydroxide precursors offers a reduction in the temperature of formation in the desired LLZO phase.

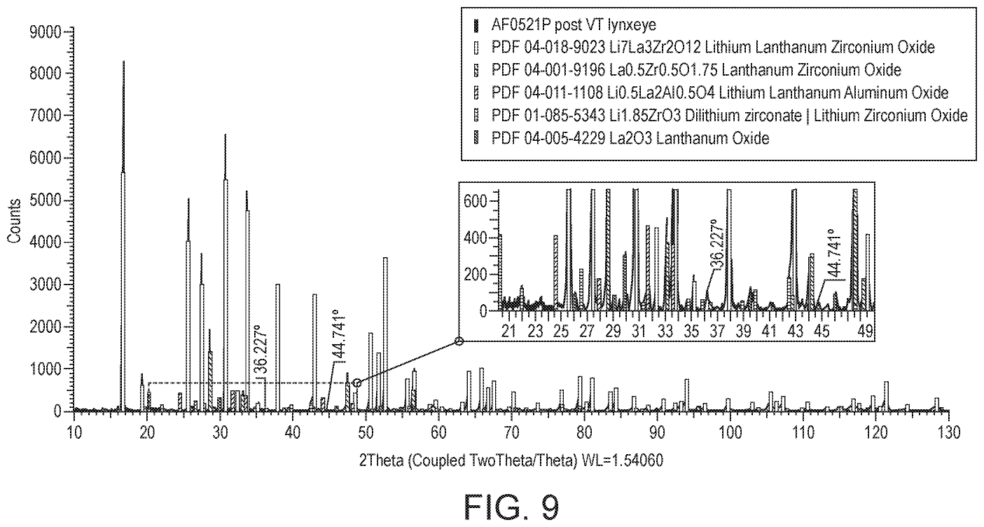

FIG. 9 shows the diffraction pattern of Example 3 after the experiment, showing the presence of the Li₇La₃Zr₂O₁₂ phase.

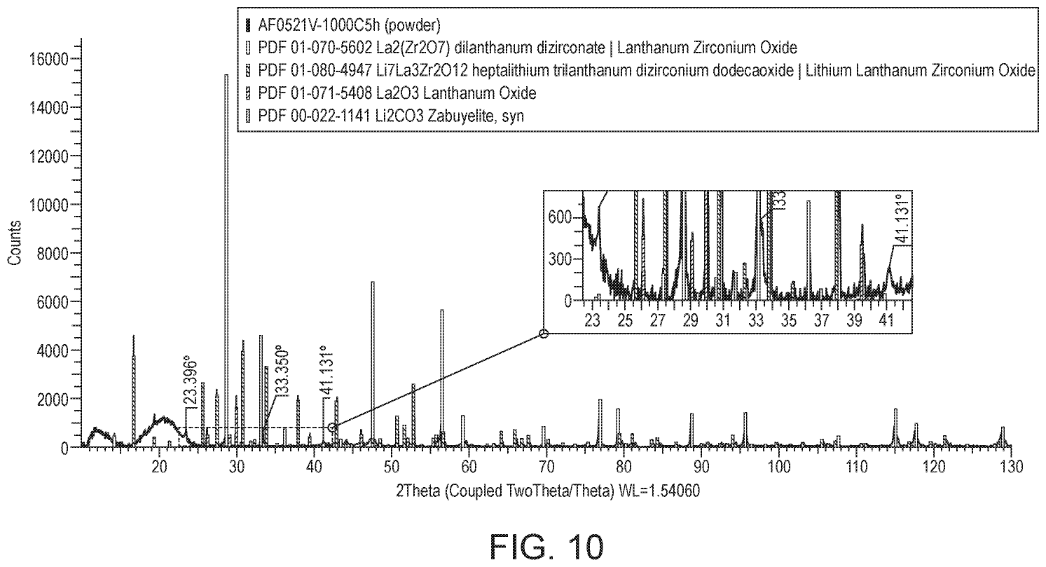

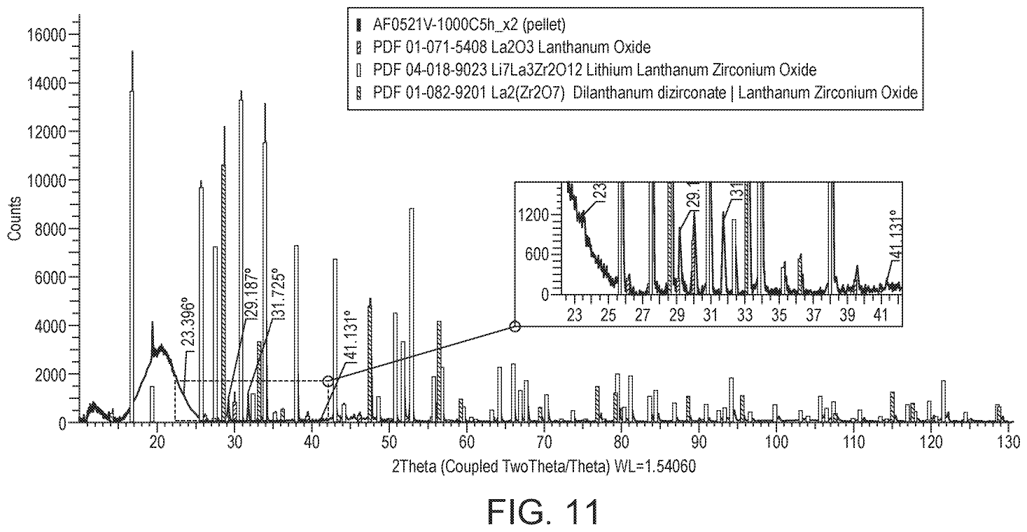

FIGS. 10 and 11 show the diffraction patterns of Examples 20 and 21 respectively. The phases identified from the XRD spectrum for Example 20 are Li₇La₃Zr₂O₁₂ (cubic), La₂Zr₂O₇, Li₂CO₃ and La₂O₃. The phases identified from the XRD spectrum for Example 21 are Li₇La₃Zr₂O₁₂ (cubic), La₂Zr₂O₇ and La₂O₃. In each of the two spectra the two broad features visible were assigned to the air-sensitive sample holder. Rietveld refinement was performed to identify the wt % fraction of each phase in the sample (see below).

X-Ray Diffraction Studies with Rietveld Refinement

The products of Examples 1 to 16, 18, 19, 20 and 21 were submitted for powder XRD analysis using the equipment and methods described above. This analysis indicated the presence of a cubic garnet phase in the product of each Example.

Rietveld refinement of the resultant spectra was performed on Examples 18, 19, 20 and 21 to establish the quantities of different phases present in the product.

Table 3 below shows the results of the Rietveld refinement analysis of the phase fraction content of Examples 18-21.

TABLE 3

| | | Phase fraction (wt %) | | | | | |
|---|---|---|---|---|---|---|---|
| | | LLZO | LLZO | | | | |
| | Annealing | cubic | tetragonal | Pyrochlore | | | |
| Example | conditions | garnet | garnet | La₂Zr₂O₇ | LaAlO₃ | La₂O₃ | Li₂CO₃ |
| 18 | 1030° C. | 40 | 58.3 | — | 1.7 | — | — |
| | 5 hrs | | | | | | |
| 19 | 1030° C. | 100 | — | — | — | — | — |
| | 13 hrs | | | | | | |
| 20 | 1000° C. | 34.6 | — | 46 | — | 8.6 | 11 |
| | 5 hrs | | | | | | |
| 21 | 1000° C. | 74.7 | — | 22.8 | — | 4.5 | — |
| | 5 hrs (×2) | | | | | | |

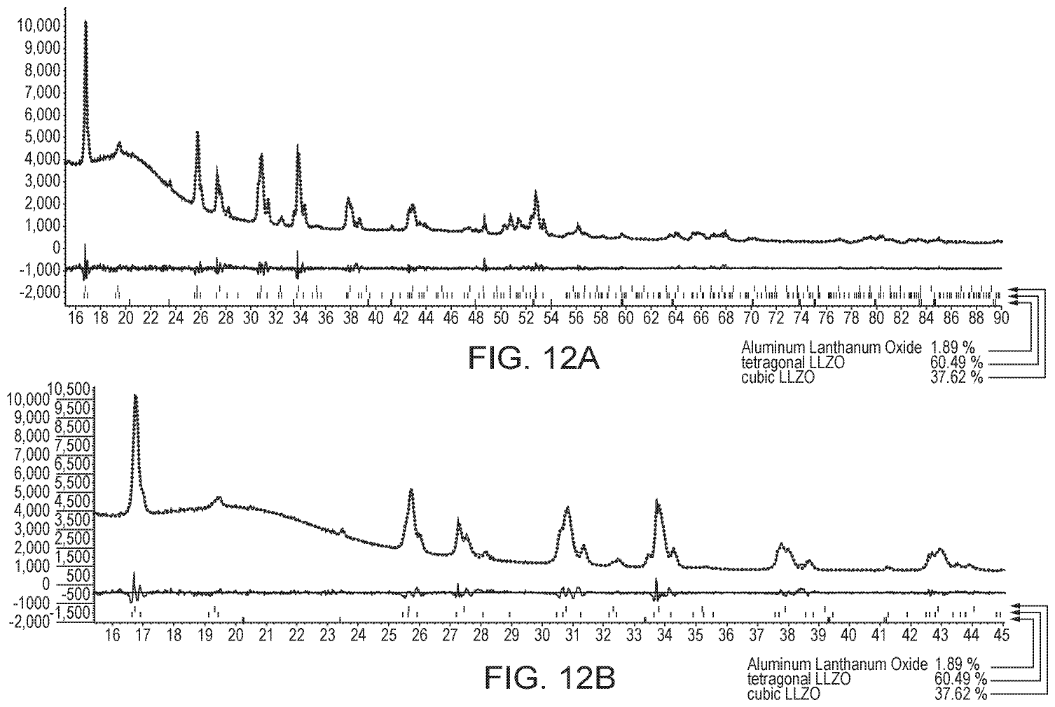

FIG. 12 shows the Rietveld XRD refinement for Example 18. FIG. 12(a) shows the overall spectrum and FIG. 12(b) shows an enlarged portion of the spectrum.

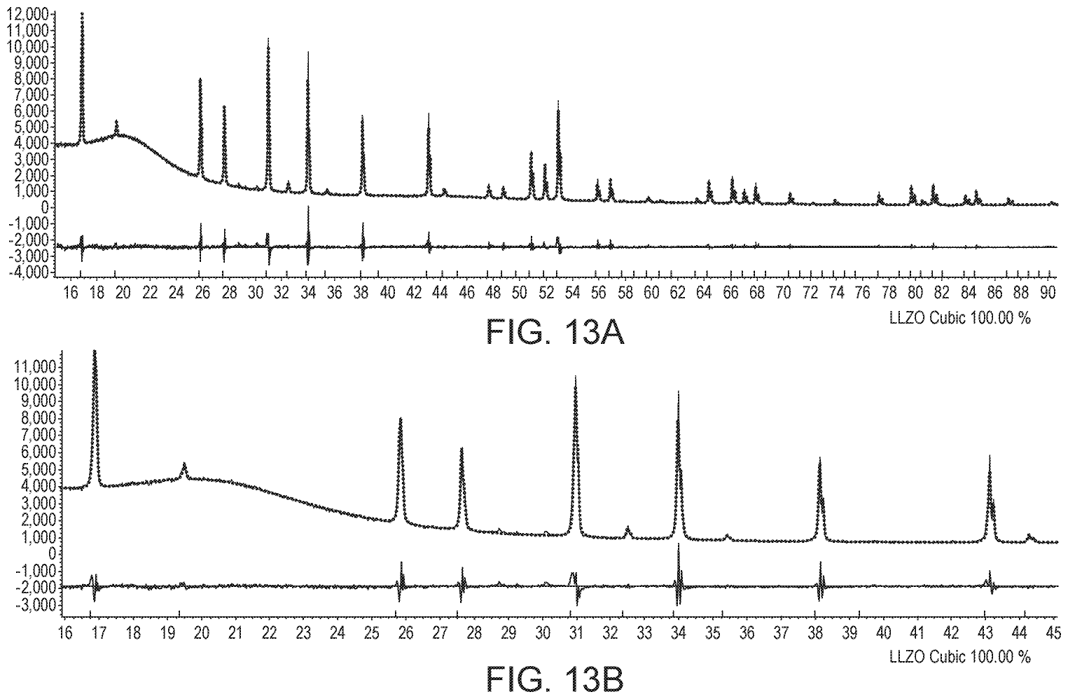

FIG. 13 shows the Rietveld XRD refinement for Example 19. FIG. 13(a) shows the overall spectrum and FIG. 13(b) shows an enlarged portion of the spectrum.

Conductivity Testing

A 13 mm diameter 1.5 mm thick pellet of the material produced in Example 1, after the spray-drying step, was pressed at 10 ton and then annealed at 1000° C. under zero-air. When cooled below 100° C. the pellet was transferred to argon atmosphere, polished, Au coated by PVD (100 nm each side) and assembled in an in-house built cell for conductivity measurement. Around 0.2 eV total conductivity activation energy of the pellet was measured by electrochemical impedance spectroscopy. This data indicated that an LLZO material with high conductivity has been obtained at least matching LLZO materials produced using less efficient prior art processes.

Impedance data was collected using a Bio-Logic VSP potentiostat at a range of temperatures from room temperature to 80° C. Total resistance at each temperature was derived from fitting the data with an equivalent circuit model to determine the maximum resistance at zero reactance. Total conductivity was calculated by geometric correction of the inverse total resistance.

Synthesis Method C

The quantities of the precursors and deionised water as set out in Table 4 were loaded into a container to make an initial slurry. This slurry was loaded into a VMA-GETZMANN Dispermat SL5-C bead mill with milling chamber prefilled with 1 mm diameter YSZ beads in portioned batches as set out in Table 4. The slurry was milled at 5000/4500 rpm agitator/recirculator setting for a total of 20 minutes per batch portion using 300-550 W power input and maintained at 20-50° C. to yield a well homogenous mixture. The mixture was then drained from the mill to a container and further batch portions similarly milled as required to complete milling for the entire batch. The mixture was then spray dried to obtain a powder using a Buchi mini spray dryer with the following process parameters: 200° C. inlet temperature, 130° C. outlet temperature, 100% aspirator flow, 30% pump flow, 3 nozzle cleaner, −60 mbar filter pressure. The powder was loaded into a crucible and annealed in an air atmosphere as set out in Table 4. The powder was removed from the furnace upon cooling under nitrogen atmosphere to 200° C. and quenched in argon. The powder was ground in a pestle under argon atmosphere and sieved to <150 μm. A pellet weighing 0.5 g was formed from the annealed material, pressed at 10 ton and sintered as set out in Table 4.

TABLE 4

Example

| | | 22 | 23 | 24 |
|---|---|---|---|---|
| precursor | LiOH•H₂O | 135.16 | 80.56 | 52.21 |
| masses (g) | La2O3 | | | 96.25 |
| | ZrO2 | | | 48.53 |
| | Al2O3 | | | 3.01 |
| | La(OH)3 | 290.51 | 150.89 | |
| | Zr(OH)4 | 162.39 | 42.17 | |
| | Al(OH)3 | 11.93 | | |
| | Nb2(OH)8•H2O | | 22.49 | |
| | Y2(CO3)3•xH2O | | 24.88 | |
| | total | 600.00 | 321.00 | 200.00 |

| | | | |
|---|---|---|---|
| slurry volume (L) | 1900 | 1300 | 600 |
| total mill energy (Wh/L) | 250 | 218.4 | 216.5 |
| mill batches portions | 3 | 2 | 1 |
| annealing temperature (° C.) | 1030 | 1030 | 1030 |
| annealing time (h) | 12 | 12 | 12 |
| sintering temperature (° C.) | 1030 | 1030 | 1030 |
| sintering time (h) | 12 | 12 | 12 |

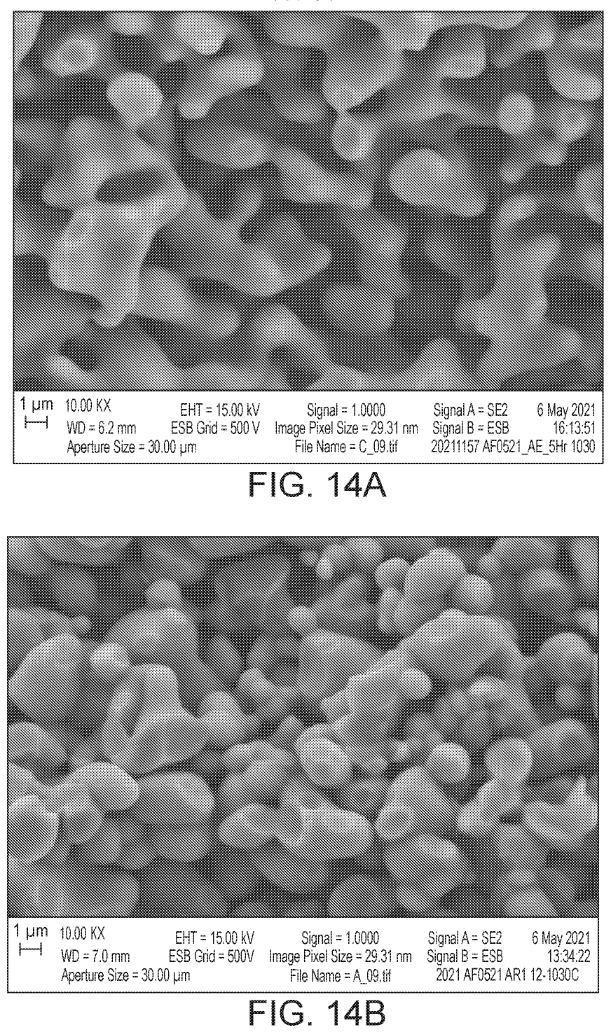

The powder materials formed in Examples 22 to 24 after the annealing step were analysed by powder XRD and in each case the main phase was found to be LLZO cubic garnet (Ex. 22, 99.8% cubic LLZO, estimated crystallite size 48 nm; Ex. 23, 98% cubic LLZO, estimated crystallite size 188 nm; Ex. 24, 98.8% cubic LLZO, estimated crystallite size 466 nm). Comparing Examples 22 and 24, the use of oxide precursors led to a lower phase purity and larger crystallite size in comparison with the annealed powder formed from hydroxide precursors (lanthanum and zirconium hydroxides). It has been observed that a lower crystallite size typically correlates with finer particle size distribution so improved sintering would be expected for materials formed from hydroxide precursors. The is exemplified in FIG. 14 which shows a cross-sectional image of LLZO materials (a) formed from La and Zr hydroxide precursors and after an annealing and then sintering step; and (b) formed from La and Zr oxide precursors and after an annealing and then sintering step. Considerably more sintering is observed for the material formed from hydroxide precursors.

1. A method of preparing a lithium lanthanum zirconate cubic garnet material comprising:
(a) milling a slurry comprising one or more precursor compounds in an aqueous medium, wherein the one or more precursor compounds comprise lithium, lanthanum, zirconium and optionally one or more dopant elements, to provide a milled slurry;
(b) spray drying the milled slurry to provide a spray-dried powder; and
(c) annealing the spray-dried powder.

2. The method according to claim 1, wherein step (c) comprises annealing the spray dried powder at a temperature of up to 1200° C.

3. The method according to claim 2, wherein step (c) comprises annealing the spray dried powder at a temperature of up to 800° C.

4. The method according to claim 1, wherein step (c) comprises annealing the spray dried powder for up to 15 hours.

5. The method according to claim 1, wherein step (c) comprises annealing the spray dried powder at a temperature of at least 550° C. and up to 1200° C.

6. The method according to claim 1, wherein the aqueous medium comprises greater than 60 wt % water.

7. The method according to claim 6, wherein the aqueous medium consists essentially of water.

8. The method according to claim 1, wherein the one or more precursor compounds comprise lithium, lanthanum, zirconium and one or more dopant elements.

9. The method according to claim 8, wherein the one or more dopant elements are each independently selected from Al, Ga, In, Sc, Y, Ge, Si, W, Ta, Hf, Nb, Ca, Ba, Sr, Mg, Sb, Sn, Te, Cl and Br.

10. The method according to claim 9, wherein the one or more precursor compounds comprise lithium, lanthanum, zirconium and aluminium.

11. The method according to claim 1, wherein the precursor compounds are selected from oxides, hydroxides, carbonates, nitrates, oxyhydroxides and hydrated forms thereof.

12. The method according to claim 11, wherein the precursor compounds comprise lanthanum hydroxide and/or zirconium hydroxide.

13. The method according to claim 1, wherein the milling of the slurry comprises ball-milling, attritor milling, high-shear mixing or homogenization.

14. The method according to claim 1, wherein the milling of the slurry comprises low-energy milling.

15. The method according to claim 1, wherein after the spray drying of the milled slurry and before annealing, the method comprises forming the spray dried powder into a shaped body.

16. The method according to claim 1, wherein step (c) comprises annealing in air which has been filtered to contain less than 0.1 ppm total hydrocarbons.

17. The method according to claim 1, further comprising prior to step (a) a step of dispersing one or more precursor compounds comprising lithium, lanthanum, zirconium and optionally one or more dopant elements in an aqueous medium to provide a slurry.

18. The method according to claim 1, further comprising, after step (c), a step of milling the annealed powder.

19. The method according to claim 1, the method being performed with only one annealing step.

20. A lithium lanthanum zirconate cubic garnet material obtained or obtainable by a process according to claim 1.

21. A method of making a lithium lanthanum zirconate cubic garnet sintered body comprising the following steps:
(a) milling a slurry comprising one or more precursor compounds in an aqueous medium, wherein the one or more precursor compounds comprise lithium, lanthanum, zirconium and optionally one or more dopant elements, to provide a milled slurry;
(b) (i) spray drying the milled slurry to provide a spray dried powder;
(ii) loading the spray dried powder into a mould; and
(c) annealing the spray dried powder.

22. A lithium lanthanum zirconate cubic garnet sintered body obtained or obtainable by a process according to claim 21.

23. The lithium lanthanum zirconate cubic garnet sintered body according to claim 22, wherein the sintered body is a solid electrolyte for use in a lithium ion battery.

24. A method of preparing a lithium lanthanum zirconate cubic garnet spray-dried precursor material, comprising:
(i) milling a slurry comprising one or more precursor compounds in an aqueous medium, wherein the one or more precursor compounds comprise lithium, lanthanum, zirconium and optionally one or more dopant elements, to provide a milled slurry; and
(ii) spray drying the milled slurry to provide a spray dried powder.
